(19) United States
(12) Patent Application Publication
(10) Pub. No.: US 2026/0365140 A1
(43) Pub. Date: Nov. 19, 2026

(54) FIXTURE FOR A BATTERY AND KEY FOB INCLUDING SUCH FIXTURE

(71) Applicant: AUMOVIO Germany GmbH, Frankfurt am Main (DE)

(72) Inventor: Milan Talpes, Timisoara (RO)

(73) Assignee: AUMOVIO Germany GmbH, Frankfurt am Main (DE)

(21) Appl. No.: 19/680,480

(22) Filed: May 18, 2026

(30) Foreign Application Priority Data
May 19, 2025 (EP) 25465525.1
May 20, 2025 (DE) 10 2025 119 450.5

(51) Int. Cl. B60R 25/40; H01M 50/202; H01M 50/244; H01M 50/264; H01M 50/284

(52) U.S. Cl. CPC B60R 25/406; H01M 50/202; H01M 50/244; H01M 50/264; H01M 50/284; B60R 2325/101

(57) ABSTRACT

The present disclosure relates to relate to a fixture for a battery and a key fob including such fixture. The fixture comprises a holding member (also referred to herein as “battery holder”) configured to hold a battery of a first battery size in contact with battery terminals and a cap (also referred to herein as “battery cap”) for the holding member, wherein the cap is configured to hold a battery of a second (smaller) battery size in contact with the battery terminals.

### CROSS-REFERENCE TO RELATED APPLICATIONS

This US patent application claims the benefit of European patent application No. 25465525.1, filed on May 19, 2025, and German patent application No. 10 2025 119 450.5, filed on May 20, 2025, both of which are hereby incorporated by reference.

### TECHNICAL FIELD

Embodiments of the present disclosure relate to a fixture for a battery and a key fob including such fixture.

### BACKGROUND

Several electronic devices are powered by batteries. Examples include key fobs (radio keys), e.g., for vehicles. Available mechanical concepts of key-fobs allowed to accommodate only one coin cell battery (usually CR2032). That limits the flexibility when replacing the battery and requires that a certain battery size which fits a battery fixture is available.

Hence, there may be a demand for an improved concept of a fixture for a battery.

### SUMMARY

This demand may be satisfied by the subject-matter of the present disclosure.

Embodiments provide a fixture for a battery. The fixture comprises a holding member (also referred to herein as “battery holder”) configured to hold a battery of a first battery size in contact with battery terminals and a cap (also referred to herein as “battery cap”) for the holding member, wherein the cap is configured to hold a battery of a second (smaller) battery size in contact with the battery terminals.

In this way, the cap compensates the difference of the first and the second (smaller) battery size such that it holds battery in place for contact the terminals. In other words, the cap prevents the battery from moving and, thereby losing contact to the terminals. This allows the use of the first and the second battery size which provides more flexibility when it comes to replacing the battery. In this way, the maintenance of electronic devices including such fixture is facilitated.

In practice, the fixture may be configured for replacing the battery. In this way, the battery may be replaced for maintenance, e.g., when it is empty.

In some embodiments, the holding member and/or the cap comprises one or more fixing means to attach the cap to the holding member. In this way, a relative position of the cap to the holding member is fixed. This holds the cap in place (independently from surrounding parts).

In some embodiments, the one or more fixing means comprise fixing means for attaching the cap to the holding member for holding the battery of the second size in contact with the battery terminals. This fixes the cap to the holding member and makes obsolete surrounding parts for supporting the cap and/or holding member.

In some embodiments, the fixing means for holding the cap are configured to attach the cap detachably to the holding member. In this way, the cap may be detached if needed, e.g., for replacing the battery. In examples, the fixing means comprise a rotation mechanism for attaching the cap (detachably/in a removable way) to the holding member.

In some embodiments, the fixing means include fixing means for storing the cap when not holding the battery (of the second battery size). In this way, the cap can be (detachably) attached to a housing of the battery-powered device or to the holding member when not in use. This may make sure that the cap will not get lost when it is not assembled for holding a battery of the second battery size. So, said fixing means may improve the handling of the fixture.

In some embodiments, the holding member exhibits a bay for positioning the battery upon a contact spring adjacent to an axial face of the battery. So, the bay prevents the battery from moving in a radial direction in order to keep them in contact with the terminals.

In some embodiments, the battery terminals include a contact spring adjacent to a first axial side of the battery when inserted in the holding member, the first and the second battery size differ from each other in their height in axial direction, and the cap is configured to push the battery of the second battery size from a second axial side opposite to the first opposite side in the axial direction against the contact spring to hold the first axial side of the battery in contact with the contact spring.

The contact spring is configured and allows to ensure continuous contact with the battery when the battery moves within the range of an axial clearance or mechanical play of the battery when inserted. This may make sure that the battery stays in contact with the contact spring even if the fixture moves or shakes.

Without the cap, the battery of the second battery size may be able to move in the axial direction so that it loses contact to the contact spring. By pushing the battery towards the contact spring, the cap keeps the battery in contact the contact spring. In practice, the cap may be configured such that it pushes the battery against the contact spring so that the contact spring is under tension when the cap is assembled. In this way, the contact spring is able to compensate movement of the battery within a certain clearance or mechanical play.

In some embodiments, the cap is configured to protrude at least as far into the bay in axial direction as the difference of the first and the second battery size in the axial direction for holding the battery in contact with the contact spring. In such embodiments, the bay may be as deep in axial direction such that a second side of a battery of the first battery size rests against one or more protrusions (e.g., in the form of fingers) at an upper edge of the bay. In this way, an overlying part (e.g., a part of a housing of the electronic device) pushes the battery of the first battery size against/towards the contact spring. In practice, the battery may be a coin cell battery and the coin cell battery of the first size and coin cell battery of the second size may differ from each other in their height in axial direction. So, the second battery size may be smaller/less tall than the first battery size in the axial direction (when being inserted in the bay). The cap protruding into the bay in axial direction may compensate that difference of the first and the second battery size such that it holds the battery of the second battery size in contact with the terminals including the contact spring.

In practice, the battery of the first battery size may be a CR2477 coin cell battery and the battery of the second size may be a CR2450 coin cell battery. The CR 2477 coin cell battery is 24.5 mm in diameter and 7.7 mm high (in axial direction). The CR2450 coin cell battery is 24.5 mm in diameter and 5.0 mm high (in axial direction). In this case, the cap, e.g., protrudes at least 2.7 mm into the bay to compensate that difference. In practice, the cap may protrude less or more into the bay within a mechanical play or range/deflection of the contact spring.

Further embodiments provide a (battery-powered) key fob including a housing and a fixture according to the present disclosure.

In some embodiments, the key fob further includes at least one circuitry for wireless communication with a receiver. In this way, the receiver may be controlled using the key fob, e.g., for locking/unlocking.

In some embodiments, the receiver includes a receiver for a vehicle, and the circuitry is configured for communication with the receiver for locking and/or unlocking the vehicle.

In some embodiments, the circuitry is configured for wireless communication with the receiver via ultra-wide band and/or Bluetooth.

Further, embodiments are now described with reference to the attached drawings. It should be noted that the embodiments illustrated by the referenced drawings show merely optional embodiments as an example and that the scope of the present disclosure is by no means limited to the embodiments presented.

### BRIEF DESCRIPTION OF THE DRAWINGS

FIG. 1 shows an example of a fixture for a battery for a battery-powered device (here: key fob);

FIG. 2 shows the fixture, and a battery of a first battery size inserted in the fixture;

FIG. 3 shows the fixture, and a battery of a second (smaller) battery size inserted in the fixture;

FIG. 4 shows an upper side (in axial direction) of an example of a cap (battery cap) for holding the battery of the second battery size in contact with terminals for the battery;

FIG. 5 shows a lower side (in axial direction) of an example of a cap (battery cap) for holding the battery of the second battery size in contact with terminals for the battery;

FIG. 6 shows an exemplary housing part of the battery-powered device with fixing means for attaching the cap to the housing;

FIG. 7 shows the housing part, and the cap attached to the housing part;

FIG. 8a-8c show how the cap may be assembled to hold the battery of the second battery size; and

FIG. 9 shows a view of the electronic device in an assembled state.

### DETAILED DESCRIPTION

As mentioned above, in some applications, it may be desired to use different battery sizes. For example, a key fob's battery consumption may request that two different types of coin cell batteries could be necessary to be accommodated in the same overall dimensions of the key fob.

In particular, the present disclosure suggests a solution to accommodate inside a key fob two types of coin cell batteries (having the same diameter and different heights), by using an addition part referred to herein as “cap” or “battery cap”. A skilled person will appreciate that the subject-matter of the present disclosure is not limited only to key fobs and coin cell batteries but may be analogously applied to other battery-powered devices and other (types of) batteries.

Accordingly, features and aspects mentioned herein with reference to a key fob and/or coin cell batteries cannot be understood as limited to the present examples and may be similarly applied to other use cases of battery fixtures.

As well, the present approach is not limited to a certain design of the device. It is noted that, the present disclosure, reference is made to a generic styling, design, and dimensions of such device (here: a key fob) and that the proposed solution can be applied to any key-fob whose overall dimensions, design, and styling allow it.

Further features and aspects are now described below with reference to the appended drawings.

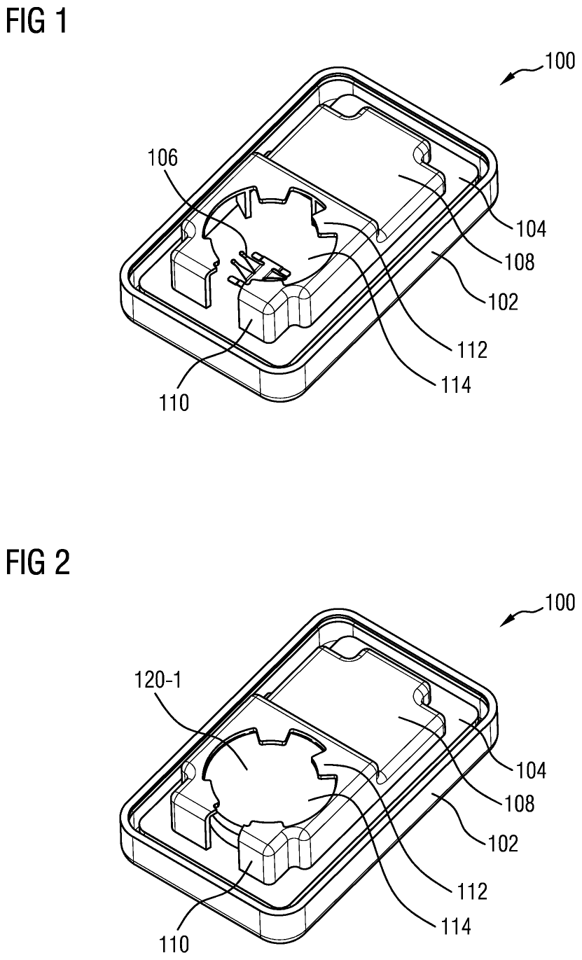

FIG. 1 shows an example of a fixture for a battery for a battery-powered device 100. In the present example, the device 100, e.g., is a battery-powered key fob.

The fixture comprises a holding member 110 configured to hold a battery of a first battery size in contact with battery terminals.

As can be seen, the holding member 110 exhibits a bay 114 configured to accommodate the battery and hold the battery in place in a radial or lateral direction.

In the present example, e.g., the battery has a cylindrical shape. The bay 114 as a round or cylindrical shape as well. To accommodate the battery, an inner diameter of the bay is at least as large as an outer diameter of the battery, as can be seen in FIG. 2 which shows the fixture, and a battery 120-1 of a first battery size inserted in the holding member 110.

As can be seen, the holding member 110 may be mounted on circuitry 104 of the key fob 100. Examples of the circuitry 104 include a printed circuit board (PCB) In the present example, the holding member 110 is placed adjacent to the circuitry 104 in an axial direction.

Further, the key fob 100 comprises terminals for the battery. In the present example, one of the batterie's poles is at an axial side of the battery and points into the direction of the circuitry in axial direction. The other pole is at a circumference of the battery.

Accordingly, one of the terminals is arranged to contact the circumference of the battery while the other terminal is placed adjacent to the axial pole side. The present example, the terminals include a contact spring 106 which is arranged adjacent to the axial pole side to contact and push against it from an axial direction.

The holding member 110 includes protrusions 112 extending inward the bay 114 from its upper edge or any other kind of boundary/stop in axial direction to keep the battery 120-1 pushed against the contact spring 106 for a permanent contact with it. The depth or height of the bay 114 or the protrusions 112 is not deeper/higher than a range of the contact spring 106 and the batterie's 120-1 height to ensure a permanent contact of the battery 120-1 with the contact spring 106.

In other words, the battery is placed inside the bay 114 provided by the holding member 110 fixed on the circuitry and a height (in axial direction with respect to the contact spring 106) of the battery 120-1 is kept in position by the protrusions 112 of the holding member 110, while being pushed upward by the contact spring 106. In other examples, the bay 114 may exhibit other means to hold the battery in place in the axial direction at the side opposite to the contact spring 106.

Further, the holding member 110 comprises a lower part 108 next to the bay 114 in a radial direction.

The key fob 100 further comprises a housing. FIGS. 1 and 2 show a part 102 of such housing which is configured to enclose the circuitry 104, the battery, and the fixture.

In practice, the holding member 110 is configured to replace the battery for maintenance. In some applications, it may be desired to replace the battery 120-1 by a different battery of the different battery size, e.g., if the previous battery size (first battery size) is not available. In practice, it may be desired to replace the battery 120-1 by a smaller battery which may be similar in their diameter but smaller in the axial direction (i.e., less high) than battery 120-1.

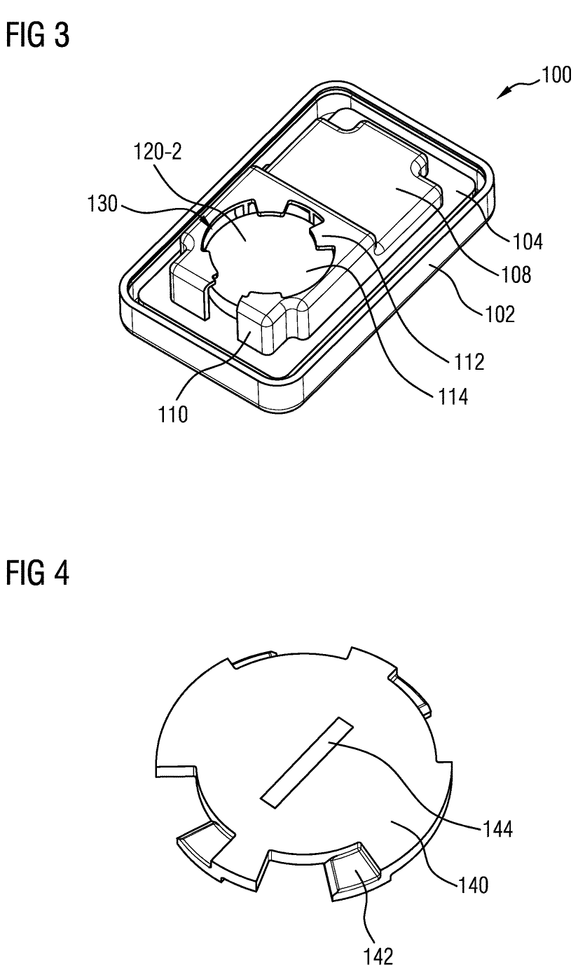

That use case is described in more detail below with reference to FIG. 3.

FIG. 3 shows the fixture, and a battery 120-2 of a second (smaller) battery size inserted in the holding member 110.

Since, the battery 120-2 of a smaller (second) battery size in the axial direction, there is a gap 130 in axial direction between the battery 120-2 and the protrusions 112. In this case, the battery 120-2 could move in the axial direction and lose contact to the contact spring 106. As a result, the device loses the power supply necessary for operation and fails.

In other words, in case of the replacement of the battery which the holding member 110 is designed for, with a smaller battery from height point of view, then a gap between this smaller battery and the features described will occur, and the electric contact between the battery and the contact spring will be lost, therefore the key-fob functionality will be lost.

The suggested fixture provides a solution to hold the battery 120-2 in place and prevent the battery 120-2 from losing contact to the terminals (contact spring 106).

More specifically, the proposed solution provides a (battery) cap to solve the above problem. In the present example, the cap, e.g., is placed in the bay 114 to compensate the size difference of the batteries 120-1 and 120-2.

In other words, the first and the second battery size differ from each other in their height in axial direction, and the cap is configured to push the battery of the second battery size from a second axial side opposite to the contact spring in the axial direction against the contact spring to hold the battery in contact with the contact spring.

More features and aspects of this solution are described below with reference to FIG. 4.

FIG. 4 shows an example of a cap 140 (battery cap) for holding the battery of the second battery size in contact with terminals for the battery (in the same bay 114 as the battery of the first battery size). More specifically, FIG. 4 shows an upper side of the cap.

In practice, the holding member 110 and/or the cap 140 may be made of plastic.

As can be seen, the cap 140 has one or more fixing means 142 for fixing the cap 140 to the holding member 110 for holding the battery 120-2 in contact with the terminals, in particular, in contact with the contact spring 106.

In the present example, the fixing means 142 include flaps which are positioned at a circumference of the cap 140 such that can hook under the protrusions 112 of the holding member, as laid out in more detail later.

A skilled person will appreciate that, alternatively, other types of fixing means can be used.

The fixing means are configured to attach the cap detachably to the holding member, as laid out in more detail later.

As well, the cap 140 exhibits means for a tool for assembling the cap 140. The present example, the cap 140 exhibits a slot for a coin or a generic tool for assembling the cap 140.

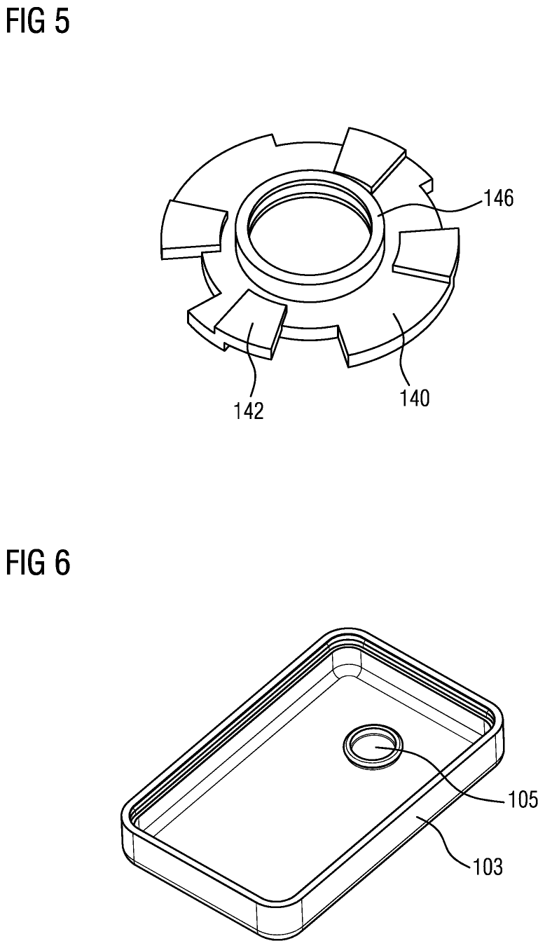

FIG. 5 shows a lower side (in axial direction) of an example of a cap (battery cap) for holding the battery of the second battery size in contact with terminals for the battery.

As can be seen, the cap 140 may further exhibit a contact member 146 for the contact with the battery 120-2 which is configured to push the battery 120-2 towards the contact spring 106.

In the present example, the contact member 146 includes a spacer ring. In this way, the cap 140 protrudes in the axial direction towards the contact spring 106 to such an extent that the difference of the battery sizes of batteries 120-1 and 120-2 is compensated. In other words, the cap 140 is configured to protrude at least as far into the bay 114 in axial direction (towards the contact spring 106106) as the difference of the first and the second battery size in the axial direction for holding the battery in contact with the contact spring. In this way, the battery 120-2 will be permanently pressed against the contact spring 106 such that the contact spring 106 is preloaded or pressurized. As a result, the battery 120-2 stays in contact with the contact spring 106 even when the battery moves in the range of a predetermined mechanical play or clearance.

As well, the fixing means can include fixing means for storing the cap 140 when not holding the battery (120-2 of the second battery size). The present example, the fixing means, e.g., comprise a fixation groove in the distance ring where an appropriate counterpart of the holding member 110, of the housing, or of any other surrounding part may snap in to hold the cap 140, as lait out in more detail below with reference to FIG. 6.

FIG. 6 shows an exemplary housing part 103 of the battery-powered device with fixing means 105 for attaching the cap 140 to the housing. In the present example, the fixing means 105 comprise a ring which protrudes from an inner surface of the housing part 103 in which is configured to snap in the fixation groove.

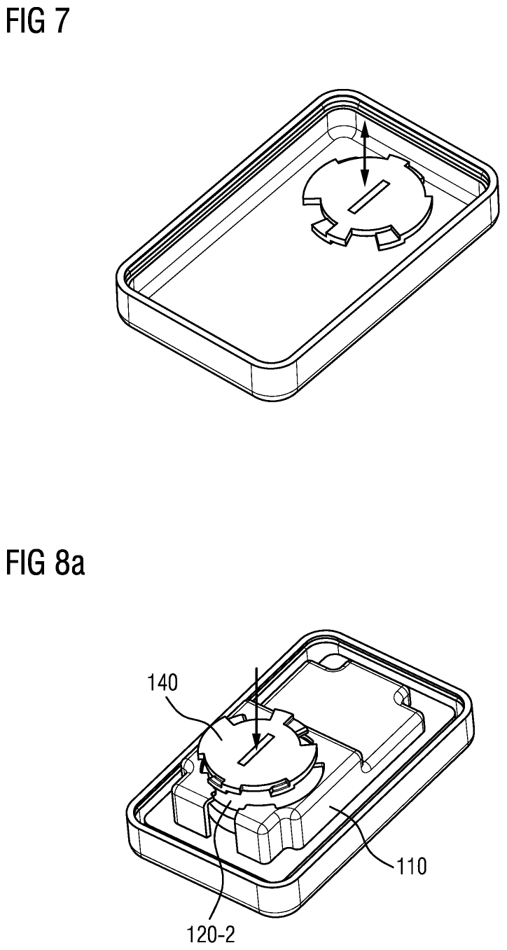

This allows to store or “park” the cap 140 when it is not in use for holding the battery 120-2 to avoid that the cap 140 can get lost and to facilitate the handling. In other words, this allows to store the cap 140 in a so-called “parked position”, as illustrated in FIG. 7.

To store the cap 140 inside the housing, the lower part 108 next to the bay 114 may be less high/lower than the bay 114 to leave enough space for the cap 140 inside the housing, here: between the (lower) housing and the holding member 110 (lower part 108).

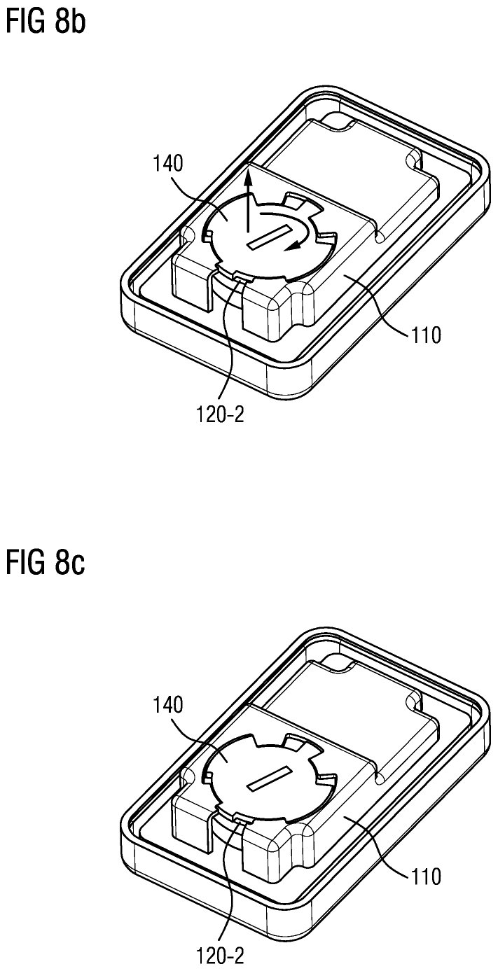

FIG. 8a-8c show how the cap 140 may be assembled to hold the battery 120-2 of the second battery size.

For this, in a first step, the battery 120-2 is inserted in the holding member 110. Then, the cap 140 is placed or brought in the holding member 110 from above, i.e., in the axial direction from an axial side opposite to the axial terminal (contact spring 106). For this the flaps are pushed through gaps between the protrusions 112 and pressed against the battery 120-2 from above (see FIG. 8a).

In a next step, the cap is twisted so that the flaps are positioned under the protrusions 112. In this way, the flaps hook under the protrusions 112 to hold the cap 140 in place while the cap 140 presses the battery 120-2 onto the contact spring 106 (see FIG. 8b). For this, a coin or a generic tool may be inserted in the slot and used it to twist the cap.

FIG. 8c shows the cap 140 in the so-called “active” position, i.e., when it is assembled to hold the battery 120-2.

In conclusion, the idea of the present disclosure is based on the usage of an additional part (here: cap 140) which can be kept in a so-called “parked position” inside the key-fob in case a taller battery is used or be mounted in so called “active position” on top of a smaller battery to compensate the height difference and to keep the proper electrical contact between the battery and the contact spring.

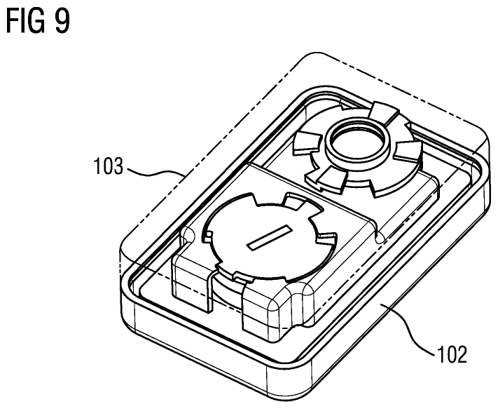

FIG. 9 shows a view of the electronic device in an assembled state. As can be seen, the housing parts 102 and 103 are assembled together to enclose the battery fixture, the battery and the circuitry.

So, the present approach suggests a solution to accommodate two different types of batteries, e.g., coin cell batteries (e.g., a CR2477 coin cell battery and a CR2450 coin cell battery) inside a key-fob, without changing the styling and design intent of the customer and without using of any special tools or know-how by the end-user.

The mounting process is relatively simple and is ensuring the same degree of fixation and reliability of fixation compared with the classic previously used concepts.

The alternative solution to accommodate two types of coin cell batteries would have mean to design and build two different holders and two different lower housings, with a direct negative impact on Bill of Material and costs.

In practice, the circuitry may be configured for wireless communication with a receiver, e.g., of a vehicle for communication with the receiver for locking and/or unlocking the vehicle.

In practice, the circuitry may support Bluetooth (Low Energy) and/or

Ultra-wideband communication. In other words, the circuitry may be configured for wireless communication with the receiver via ultra-wide band and/or Bluetooth.

It is noted that, even though, FIG. 9 may show two caps-one in parked and one in active position, the fixture may only include one cap either in parked or in active position. FIG. 9 only shows a cap in each position to illustrate how the cap is accommodated in both positions in the housing

In the foregoing description, it can be seen that various features are grouped together in examples for the purpose of streamlining the disclosure. This method of disclosure is not to be interpreted as reflecting an intention that the claimed examples require more features than are expressly recited in each claim. Rather, as the following claims reflect, subject matter may lie in less than all features of a single disclosed example. Thus, the following claims are hereby incorporated into the description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

Although specific embodiments have been illustrated and described herein, it will be appreciated by those of ordinary skill in the art that a variety of alternate and/or equivalent implementations may be substituted for the specific embodiments shown and described without departing from the scope of the present embodiments. This application is intended to cover any adaptations or variations of the specific embodiments discussed herein. Therefore, it is intended that the embodiments be limited only by the claims and the equivalents thereof.

1. A fixture for a battery, the fixture comprising:
a holding member configured to hold a battery of a first battery size in contact with battery terminals; and
a cap for the holding member, wherein the cap is configured to hold a battery of a second battery size in contact with the battery terminals.

2. The fixture of claim 1, wherein the holding member and/or the cap comprises one or more fixing means to attach the cap to the holding member.

3. The fixture of claim 2, wherein the one or more fixing means comprise fixing means for attaching the cap to the holding member for holding the battery of the second size in contact with the battery terminals.

4. The fixture of claim 3, wherein the fixing means to attach the cap detachably to the holding member.

5. The fixture of claim 2, wherein the fixing means include fixing means for storing the cap when not holding the battery.

6. The fixture of claim 1, wherein the holding member exhibits a bay for positioning the battery upon a contact spring adjacent to an axial face of the battery.

7. The fixture of claim 6, wherein the battery terminals include a contact spring adjacent to a first axial side of the battery when inserted in the holding member, wherein the first and the second battery size differ from each other in their height in axial direction, and wherein the cap is configured to push the battery of the second battery size from a second axial side opposite to the first opposite side in the axial direction against the contact spring to hold the battery in contact with the contact spring.

8. The fixture of claim 7, wherein the cap is configured to protrude at least as far into the bay in axial direction as the difference of the first and the second battery size in the axial direction for holding the battery in contact with the contact spring.

9. The fixture of claim 1, wherein the battery is a coin cell battery, and wherein the coin cell battery of the first size and coin cell battery of the second size differ from each other in their height in axial direction.

10. The fixture of claim 9, wherein the battery of the first battery size is a CR2477 coin cell battery, and the battery of the second size is a CR2450 coin cell battery.

11. The fixture of claim 1, wherein the fixture is configured for replacing the battery.

12. A key fob, comprising:
a housing; and
a fixture for a battery, the fixture comprising:
a holding member configured to hold a battery of a first battery size in contact with battery terminals; and
a cap for the holding member, wherein the cap is configured to hold a battery of a second battery size in contact with the battery terminals.

13. The key fob of claim 12, wherein the key fob further includes at least one circuitry for wireless communication with a receiver.

14. The key fob of claim 13, wherein the receiver includes a receiver for a vehicle, and wherein the circuitry is configured for communication with the receiver for locking and/or unlocking the vehicle.

15. The key fob of claim 13, wherein the circuitry is configured for wireless communication with the receiver via ultra-wide band and/or Bluetooth.
